(19) United States
(12) Patent Application Publication
(10) Pub. No.: US 2025/0335210 A1
(43) Pub. Date: Oct. 30, 2025

(54) DATA READING METHOD AND APPARATUS, AND ELECTRONIC DEVICE

(71) Applicants: Zheng Yang, Huangshi, Hubei (CN); Cong Lu, Huangshi, Hubei (CN)

(72) Inventor: Zheng YANG, Huangshi, Hubei (CN)

(21) Appl. No.: 18/867,249

(22) PCT Filed: Nov. 8, 2022
(86) PCT No.: PCT/CN2022/130597

§ 371 Date: Nov. 19, 2024

(30) Foreign Application Priority Data
Jun. 10, 2022 (CN) 202210653784.2

(51) Int. Cl. G06F 9/445

(52) U.S. Cl. CPC G06F 9/4451

(57) ABSTRACT

Provided in the embodiments of the present application are a data reading method and apparatus, and an electronic device. The method includes: acquiring user behavior data and multiple page screenshots of a target application prior to a current moment, the page screenshots are obtained by capturing a display page of the target application; determining, based on the multiple page screenshots and the user behavior data, prefetch data to be read by the target application next time; and downloading the prefetch data from a first server and storing the prefetch data in a local storage device, so that when a next read request for the target application hits the prefetch data, the prefetch data is read from the local storage device.

### CROSS-REFERENCE TO RELATED APPLICATIONS

This application claims priority to Chinese patent application No. 202210653784.2, entitled “DATA READING METHOD AND APPARATUS, AND ELECTRONIC DEVICE”, filed with the China National Intellectual Property Administration on Jun. 10, 2022, which is incorporated herein by reference in its entirety.

### TECHNICAL FIELD

This application relates to the field of communication processing technology, and in particular, to a data reading method, a data reading apparatus and an electronic device.

### BACKGROUND

With the popularization of various applications, users generally download various applications on terminals for use. For example, many APPs are installed on mobile phones.

However, during the use of various applications, the application might take a long time to read data in some cases, so that the users have to wait for a long time before seeing desired contents on the page. For example, after a game APP is downloaded, the user often has to wait for a long time to enter a game scene or use some game props and skills while playing the game. Accordingly, the problem of game stuttering often happens.

### SUMMARY

In view of the above problem, embodiments of the present disclosure are proposed.

To solve the above problem, a first aspect of the present disclosure provides a data reading method, including:
acquiring user behavior data and multiple page screenshots of a target application prior to a current moment; where the page screenshots are obtained by capturing a display page of the target application;
determining, based on the multiple page screenshots and the user behavior data, prefetch data to be read by the target application next time;
downloading the prefetch data from a first server and storing the prefetch data in a local storage device, so that when a next read request for the target application hits the prefetch data, the prefetch data is read from the local storage device.

In some embodiments, the user behavior data includes multiple read data sequences, and the method further includes:
aligning the multiple page screenshots with the multiple read data sequences based on respective timestamps of the multiple page screenshots and respective timestamps of the multiple read data sequences;
the user behavior data includes multiple read data sequences, and the determining, based on the multiple page screenshots and the user behavior data, the prefetch data to be read by the target application next time includes:
determining an attention score between each page screenshot and the multiple read data sequences based on the page screenshots and corresponding read data sequences that are aligned with each other;
determining the prefetch data to be read by the target application next time based on the attention score.

In some embodiments, the determining, based on the multiple page screenshots and the user behavior data, the prefetch data to be read by the target application next time includes:
inputting the multiple page screenshots and the user behavior data into a prediction model to obtain the prefetch data to be read by the target application next time;
where the prediction model is obtained by training a target neural network with multiple joint training samples as inputs and actual read data samples corresponding to each joint training sample as the true values;
where each joint training sample includes multiple page screenshot samples and user behavior data samples, and the actual read data sample is the data actually read by the target application.

In some embodiments, the method further includes:
when an i-th data reading is executed by the target application, acquiring the actual read data sequence actually read through the i-th data reading and the prefetch data sequence corresponding to the i-th data reading; where i is an integer greater than or equal to 1;
in response to a difference between the actual read data sequence and the prefetch data sequence exceeding a target difference, acquiring the target user behavior data and the target page screenshots based on which the prefetch data sequence corresponding to the i-th data reading is determined;
updating the prediction model based on the target user behavior data, the target page screenshots and the actual read data sequence.

In some embodiments, the method further includes:
taking the target user behavior data and the target page screenshots corresponding to the i-th time as incremental samples, and adding the incremental samples to an incremental sample pool;
the updating the prediction model based on the target user behavior data, the target page screenshots and the actual read data sequence includes:
acquiring the incremental samples newly added in the current period from the incremental sample pool periodically;
updating the prediction model with the incremental samples newly added in the current period as inputs and the corresponding actual read data sequence as the true value.

In some embodiments, the user behavior data sample includes multiple read data sequence samples, and the prediction model is trained by:
acquiring first feature vectors corresponding to each of the multiple page screenshot samples and second feature vector corresponding to each of the multiple read data sequence samples;
obtaining a combined vector by concating the first feature vectors and the second feature vectors;
obtaining the prefetch data sequence output by the target neural network based on the combined vector;
updating the parameters of the target neural network multiple times based on the prefetch data sequence and the actual read data sample to obtain the prediction model.

In some embodiments, the method further includes:
acquiring current performance configuration parameters of a terminal running the target application;
the determining, based on the multiple page screenshots and the user behavior data, the prefetch data to be read by the target application next time includes:
in response to current performance configuration parameters meeting a target condition, sending the multiple page screenshots and the user behavior data to the prediction model provided in the terminal to obtain the prefetch data to be read next time;
in response to the current performance configuration parameters not meeting the target condition, sending the multiple page screenshots and the user behavior data to a second server to obtain the prefetch data to be read next time.

In some embodiments, the method includes:
before the target application is installed, acquiring a launching operation package and a launching image package of the target application in advance; where the launching image package includes startup data of the target application;
after launching the target application through the launching operation package, in response to a read request of the target application, reading the data corresponding to the read request from the launching image package and/or the first server; where the first server includes all the original data of the target application.

In some embodiments, an embodiment of this application further discloses a data reading apparatus, including:
a data acquisition module, configured to acquire user behavior data and multiple page screenshots of a target application prior to a current moment; where the page screenshots are obtained by capturing a display page of the target application;
a data prediction module, configured to determine prefetch data to be read by the target application next time based on the multiple page screenshots and the user behavior data;
a download module, configured to download the prefetch data from a first server and store the prefetch data in a local storage device, so that when a next read request for the target application hits the prefetch data, the prefetch data is read from the local storage device.

An embodiment of this application further discloses an electronic device, including a memory, a processor and a computer program that is stored on the memory and executable on the processor. When the processor executes the computer program, the data reading method according to the first aspect is implemented.

An embodiment of this application further discloses a computer readable storage medium, and a computer program stored thereon causes the processor to execute the data reading method according to the first aspect of this application.

An embodiment of this application further discloses a computer program product, including computer programs/instructions. When the computer programs/instructions are executed by the processor, the data reading method according to the first aspect is implemented.

According to the data reading method of the embodiments of this application, multiple page screenshots of a target application prior to a current moment and user behavior data can be acquired; and based on the multiple page screenshots and the user behavior data, the prefetch data to be read by the target application next time can be determined; the prefetch data is downloaded from a first server and stored in a local cache, so that when a next read request for the target application hits the prefetch data, the prefetch data is read from the local cache.

### BRIEF DESCRIPTION OF THE DRAWINGS

In order to describe technical solutions of the embodiments of the present disclosure more clearly, the accompanying drawings used in the illustration of the embodiments will be briefly introduced. Apparently, the accompanying drawings in the following explanation illustrate merely some embodiments of the present disclosure, and those skilled in the art may obtain other accompanying drawings based on these accompanying drawings without paying any creative effort.

FIG. 1 is a diagram illustrating a hardware and software environment in which a data reading method according to an embodiment of this application is executed;

FIG. 2 is a flowchart of steps of a data reading method according to an embodiment of this application;

FIG. 3 is a flowchart of steps of determining prefetch data according to an embodiment of this application;

FIG. 4 is an overall flowchart of model training according to an embodiment of this application;

FIG. 5 is a flowchart of self-iterative update of a prediction model according to an embodiment of this application;

FIG. 6a is a diagram illustrating a hardware and software environment in a server mode according to an embodiment of this application;

FIG. 6b is a diagram illustrating a hardware and software environment in a client mode according to an embodiment of this application; and

FIG. 7 is a structural framework diagram of a data reading apparatus according to an embodiment of this application.

### DETAILED DESCRIPTION

A clear and thorough description for technical solutions in the embodiments of the present disclosure will be given below in conjunction with the accompanying drawings in the embodiments of the present disclosure. Apparently, the described embodiments are a part of embodiments of the present disclosure, not all the embodiments. All other embodiments obtained, based on the embodiments in the present disclosure, by those skilled in the art without paying creative effort fall within the protection scope of the present disclosure.

Embodiments of the present disclosure may be applied to various operating systems of terminals. The terminals include personal computer (PC) terminals and mobile terminals. The operating systems include operating systems for PC such as Windows, Linux, Unix, and virtual machine simulation systems, and also include operating systems for mobile terminals such as Android and IOS.

A target application in the embodiments of the present disclosure may refer to an application program with a large software installation package and data package, such as a 3D game, photoshop (PS), and the target application may be an application program (APP) for a PC terminal or an APP for a mobile terminal. The method and system of the embodiments of the present disclosure will be described below by taking a mobile terminal as an example.

In the related art, during the use of various applications, the applications take a long time to read data in some cases. In view of this, this application proposes a data prefetching solution to solve the above technical problem. Specifically, a display page of the target application prior to a current moment may be captured to obtain multiple screenshots of the page, then prefetch data to be read by the target application next time can be determined based on the multiple screenshots and the user behavior data prior to a current moment, so as to download the prefetch data from a first server in advance and store the prefetch data in a local terminal. In this way, a duration used by the target application to read data next time is shortened, and the efficiency of data reading is improved.

On the basis of above, in some implementation scenarios, an improved solution for further improving the use fluency of a target application with a large data package is proposed. Specifically, the improved solution can accelerate the speed of download, installation and startup of the target application, and ensure the running of the target application as described below.

For a target application with a large data package, both of the download and installation of the target application take a long time, and a bandwidth resource required is large and the performance requirement for the terminal is high when the target application is used. Therefore, for a target application with a large data package, the user needs to wait for a long time when the target application is used for the first time, and the requirements for the performance of the terminal and the network bandwidth resource are also high during the use process.

In view of this, an improved solution capable of running the target application while downloading the target application is proposed. Specifically, before the target application is installed, a launching operation package and a launching image package of the target application may be acquired in advance; after the target application is launched through the launching operation package, in response to a read request for the target application, data corresponding to the read request is read from the launching image package and/or a first server including all original data of the target application.

The launching operation package is used to launch the target application, and the launching operation package includes basic files for launching the target application. When the terminal runs the target application using the launching operation package, the launching operation package is used for performing basic component installation of the target application required in the installation process and configuring interaction actions between the target application and the terminal. Therefore, the launching operation package contains a small amount of data, so that the terminal can download the launching operation package efficiently.

The launching image package includes startup data of the target application. When the terminal acquires the launching image package while acquiring the launching operation package. Thus, when the target application is launched, the data required for launching the target application may be directly acquired locally, which greatly reduces the startup time of the target application.

When it is required to read data during the running process of the target application, data corresponding to the read request can be acquired from the launching image package and/or the first server. In the case that the launching image package contains the data corresponding to the read request, the data can be directly read from the launching image package. In the case that the launching image package does not contain the data corresponding to the read request, the corresponding data can be read from the first server. In the case that the launching image package contains part of the data corresponding to the read request, all the data required can be jointly read from the first server and the launching image package.

When such implementation is adopted, the original data of the target application may be prepared as the launching operation package and the launching image package by the supplier of the target application according to the functions of the original data, data other than the launching operation package in the original data is packed as an original image package, and the launching operation package, the launching image package and the original image package are uploaded to the first server. Thus, when the target application is downloaded and installed by the user, the launching operation package and the launching image package may be downloaded first. Since the launching operation package and the launching image package contain a small amount of data, the download speed thereof is fast, so that the user can quickly launch the target application on the terminal. After the target application is launched, the data required for the read request may be acquired from the launching image package and/or the first server (the original image package), thereby helping the normal running of the target application.

Accordingly, the running speed of the target application can be improved, so that the user can use the target application as soon as possible. For example, in a game scene, for a game APP with a very large data package, a quick startup of the game APP can be realized when the user clicks to download the game APP. When the user launchs to play the game APP, the data acquisition in the process of the game can be supported by the launching image package already located in the terminal and the original image package in the first server, so that the waiting time of the user can be greatly reduced without affecting the user's game playing.

When the above data prefetching solution is combined with the improved solution, on one hand, the user can quickly launch and quickly use the target application. Moreover, during the use process, the data reading speed is improved because of the data prefetching mechanism, so that the display page has a high display fluency.

On the other hand, the launching operation package and the launching image package of the target application are stored in the terminal, and corresponding prefetch data is downloaded from the first server only during the use process of the target application. Therefore, compared with storing all the data of the target application in the terminal, the occupation of the storage resource in the terminal can be reduced, and the performance of the terminal can be ensured.

On still another hand, the prefetch data is read from the first server and stored in the local terminal in advance, as the target application is used, the data stored in the local terminal will become more and more, and the probability of directly reading data from the local will be higher. Therefore, the more the target application is used, the faster the response speed is, and the higher the user's use fluency is.

An adequate description about a hardware and software environment in which the data reading method of this application is applied and how to perform data prefetching is provided below.

Reference is made to FIG. 1, which is a schematic diagram of a hardware and software environment of the present application. As shown in FIG. 1, a terminal, a first server and a second server are included. The first server is configured to store all the original data (the original image package) required for the running of the target application, and the second server is configured to determine the prefetch data to be read by the target application next time. The terminal is configured with a prefetching module, a file management module and an application screenshot module corresponding to the target application.

The file management module has a data channel with the target application and can acquire user behavior data of the target application. The application screenshot module is configured to acquire a page screenshot of a display page. The prefetching module has respective data channels with the file management module and the application screenshot module, and can receive the user behavior data sent by the file management module and multiple page screenshots sent by the application screenshot module.

In an implementation, the file management module is configured to send the user behavior data to the prefetching module, and the application screenshot module is configured to send multiple page screenshots to the prefetching module. The prefetching module may package the user behavior data and the multiple page screenshots and send them to the second server. The second server determines the prefetch data to be read by the target application next time based on the user behavior data and the page screenshots, and then feeds back an identifier of the prefetch data to the prefetching module. Next, the prefetching module downloads the prefetch data from the first server.

The prefetching module may communicate with the first server through multiple interfaces, so as to sequentially acquire, via the multiple interfaces, the determined prefetch data from the first server. The multiple interfaces may include a content delivery network (CDN) interface, a peer-to-peer (P2P) transmission interface and a source station interface.

The file management module may be initialized when the target application is launched through the launching operation package. The application screenshot module may obtain the page screenshots as follows.

According to one way, the display page of the target application is directly captured at a preset frequency to obtain multiple page screenshots.

According to another way, a screenshot capturing component provided by the operating system of the terminal is used to take screenshots of the display page, and then image frames captured in a display buffer of a graphics memory of the terminal are acquired through calling an interface with the graphics memory, and the obtained image frames are used as the page screenshots.

Taking a 3D game as an example, the application screenshot module may call the Nvidia Game Stream interface to extract relevant image frames from a display buffer for the current 3D game in the graphics memory of the GPU. For example, the frame rate of the game in running is generally 60 to 120 fps, then image frames may be extracted at a certain sampling interval, so as to obtain multiple page screenshots.

It should be noted that the present application may perform preprocessing on the screenshots of the display page to obtain required page screenshots. The preprocessing may include adjusting an orientation and size of the screenshot and marking a timestamp of the screenshot. When adjusting the orientation of the screenshot, the orientation of the screenshot may be adjusted to be forward. When adjusting the size of the screenshot, the screenshot may be compressed to a target size.

Of course, in some other embodiments, the preprocessing on the screenshot of the display page may also include: trimming edges of the display page in the screenshot that do not belong to the target application. This situation is suitable for the case where the screenshot mechanism is a full-screen screenshot. For example, some screenshot software provided by the operating system takes a full-screen screenshot of the display screen. Thus, the screenshot will inevitably include other pictures besides the display page of the target application.

For example, in a game APP, if the game page is not displayed in full screen by the user, a full-screen screenshot of the terminal will be taken under some screenshot mechanisms. Accordingly, the screenshot will include the taskbar of the operating system and a picture on the desktop that is not covered by the game page.

Accordingly, to avoid pictures other than the display page of the target application to exist in the screenshot, an image area that belongs to the display page of the target application may be cut out of the screenshot, so as to remove the edge pictures in the screenshot that do not belong to the display page of the target application. Then, the image area cut out is used as the page screenshot described in the present application.

The data reading method of this application will be described in details below.

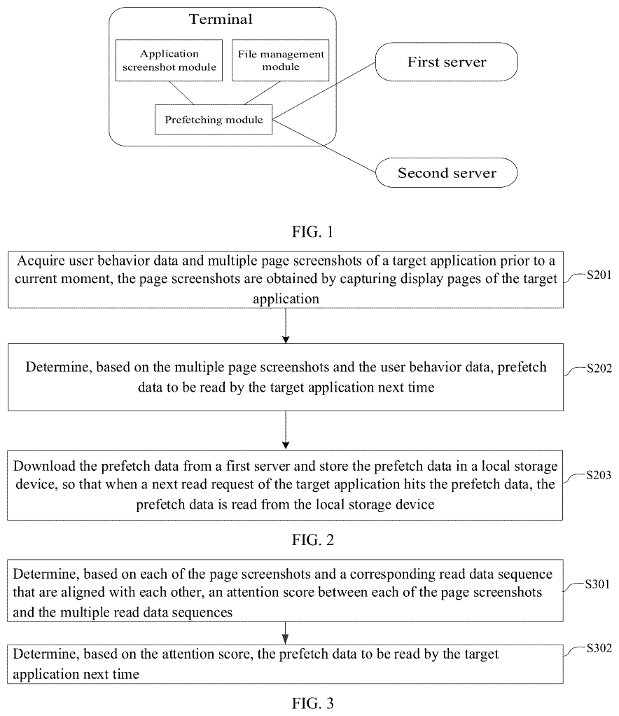

Referring to FIG. 2, a flowchart illustrating steps of the data reading method of an embodiment is shown. As shown in FIG. 2, the data reading method may specifically include steps described below.

At step S201, user behavior data and multiple page screenshots of the target application prior to a current moment are acquired.

The page screenshots are acquired by capturing the display page of the target application.

In embodiments of the application, the display page of the target application may be captured. Specifically, the display page may be captured once every preset time, such as 100 to 200 ms, so as to obtain the page screenshots. The process of capturing the display page to obtain the page screenshots may refer to the above description and will not be repeated here.

The multiple page screenshots may be obtained by capturing the display page of the target application multiple times within a preset period prior to a current moment. Correspondingly, the user behavior data may also be the behavior data within the preset period prior to the current moment. The preset period may be set as 10 s.

The user behavior data may record the user's operation behavior in the target application, including but not limited to a data reading log. The data reading log is used to record each data read within the preset period and the reading time of each data. Specifically, the data reading log may include multiple data reading records. Each of the data reading records may include an identifier of data read each time and the reading time of each reading. The reading time may be a timestamp corresponding to the reading moment.

Correspondingly, each page screenshot may also include a timestamp corresponding to the page screenshot. The timestamp may represent a moment when the display page is captured. For example, if the display page is captured at 12:12:34.100 milliseconds, a timestamp corresponding to the moment when the display page is captured may be recorded in the page screenshot obtained by the capturing.

Of course, the user behavior data not only includes the data reading records, but also includes data about the user's jump behavior between pages, data about data writing behavior, etc., and the data about the jump behavior may reflect the time when the user performs a page redirection and the display pages before and after the jump. Since the display page generally corresponds to a background resource data (the resource data may be processed and transformed into page data that can be displayed, thereby forming the display page), combined with the timestamp corresponding to the page screenshot, a stay time of the user on each display page can be known, and thus the resource data that the user is interested in within the preset period may also be obtained, which further helps to predict the data to be read by the user next time.

At step S202, prefetch data to be read by the target application next time is determined based on the multiple page screenshots and the user behavior data.

In the embodiment, each data reading record in the data reading log may be compared with a page screenshot based on the timestamp corresponding to the reading moment and the timestamp corresponding to the moment when the screenshot is obtained, so as to obtain a correlation relationship between the page screenshots and the data reading records. Through the correlation relationship, a correlation between the display page viewed by the user in the target application and the data reading behavior performed by the user when viewing a certain display page may be established.

For example, taking a game APP as an example, the multiple page screenshots may represent what game scenes have been watched by the user in the game, the data reading records may represent what data have been read by the user, and the correlation relationship may represent what data have been read by the user during the process of watching the game scene.

Of course, in some cases, a page screenshot may have no corresponding data reading record. In this case, a data reading record with a fixed identifier (for example, a data record with an identifier of “00-00-00”) may be set for this page screenshot, so that each page screenshot has a corresponding data reading record, thereby completing the correlation relationship.

In this way, based on the correlation relationship between the page screenshots and the data reading records, it can be determined whether the user has read data in the display page and which data has been read. Moreover, according to the time sequence of the page screenshots and the data reading records, a transfer trajectory among the display pages and a transfer trajectory among the data reading records can also be determined. Thus, a probability transfer matrix of the display pages and a probability transfer matrix of the user behavior data can be obtained. These two probability transfer matrices can reflect a law of the reading behavior of the user in the target application. Therefore, the prefetch data to be read by the user next time can be predicted based on these two probability transfer matrices. Specifically, it can be understood that based on the page screenshots and the behavior data, the resource data that the user is interested in within a preset period can be obtained, so that the prefetch data to be read by the user next time can be predicted with reference to the resource data that the user is interested in.

At step S203, the prefetch data is downloaded from the first server and stored in a local storage device, so that the prefetch data is read from the local storage device when the next read request for the target application hits the prefetch data.

In the embodiment, the prefetch data determined can be marked with an identifier of the prefetch data, such as the ID of the prefetch data. Thus, based on the identifier of the prefetch data, the prefetch data can be downloaded from the first server and stored in a local storage device, for example, being stored in an external storage device of the terminal. Alternatively, the prefetch data may also be stored in an internal storage device of the terminal. In this way, when the next read request for the target application hits the prefetch data, the prefetch data can be directly read from the local storage device, thus greatly shortening the data reading path and realizing the fast reading of data.

Of course, if the prefetch data only includes part of the data required by the next read request, the remaining data in the data required by the next read request that is not included in prefetch data may be downloaded from the first server. Then, the remaining data downloaded from the first server and the data hit in the prefetch data are encapsulated into a data package and fed back to the target application. In this case, since only part of the data is downloaded in real time from the first server, the amount of data to be downloaded in real time is relatively reduced, and the real-time efficiency of reading data can also be improved.

Of course, in some embodiments, the duration for downloading the prefetch data from the first server can be limited within a target duration. If the prefetch data is not downloaded within the target duration, the download of the prefetch data will no longer be carried out. Generally, the target duration may be determined based on a spacing interval between each two adjacent data readings of the user, for example, the target duration may be an average spacing interval between each two adjacent data readings. In this way, the conflict between prefetching and actual reading when the target application initiates the next read request without successfully reading the prefetch data can be avoided, so that the next read request for the target application can be responded separately and the data reading efficiency of the target application can be guaranteed.

By adopting the technical solution of the embodiment of the application, on the one hand, the prefetch data is acquired from the first server in advance and stored in the local storage device of the terminal, so that the data can be directly read from the local storage device of the terminal when the target application reads data next time. Compared with downloading the required data from the first server, the reading path may be greatly shortened by reading data from the local storage device, thereby greatly shortening the data reading duration, improving the data reading efficiency of the target application, avoiding the problem of stuttering occurred during the use of the target application, and improving the use fluency of the target application. On the other hand, the prefetch data to be read by the user next time is obtained based on the page screenshots and the user behavior data, and the correlation between the page viewing behavior and the data reading behavior of the user can be established. Based on this correlation, the data to be read by the user next time can be accurately predicted, thereby improving the probability that the next read request hits the prefetch data and further ensuring that each read request can be quickly responded.

In an embodiment, referring to FIG. 3, a flowchart illustrating steps of determining the prefetch data is shown. As mentioned above, the user behavior data may include the data reading log, and the data reading log may include multiple data reading records. The data reading record may include the identifier of the read data, such as the ID of the data. The data read each time is generally not just one data, but may be multiple data, thus each data reading record is represented as an ID sequence. Accordingly, one data reading record may be called a read data sequence, and multiple data reading records are multiple read data sequences.

For example, if data with IDs “01”, “02” and “03” need to be read in one data reading, the data reading record is represented as an ID sequence of “01-02-03”.

As mentioned above, it is necessary to determine the correlation relationship between the page screenshots and the multiple read data sequences. In practice, in order to accurately map the viewing behavior and the data reading behavior of the user on the display page, the multiple page screenshots and the multiple read data sequences may be aligned with each other first, that is, one page screenshot may map one read data sequence, so as to accurately map the user's viewing behavior and data reading behavior.

Specifically, the multiple page screenshots and the multiple read data sequences may be aligned based on the respective timestamps of the multiple page screenshots and the respective timestamps of the multiple read data sequences.

According to a specific implementation, for each page screenshot, based on a timestamp corresponding to the page screenshot, a read data sequence that matches the timestamp may be taken as the read data sequence aligned with the page screenshot.

For example, if the moment corresponding to page screenshot 1 is 34 seconds and 200 milliseconds, the read data sequence whose reading time is around 34 seconds and 200 milliseconds may be aligned with page screenshot 1. Here, “around 34 seconds and 200 milliseconds” means a time difference between the reading time and 34 seconds and 200 milliseconds is within a target time difference range. That is, when aligning, the read data sequence that matches the timestamp corresponding to the page screenshot means a read data sequence, for which the time difference between the timestamp corresponding to the reading time and the timestamp corresponding to the page screenshot is within the target time difference range.

In an embodiment, before the page screenshots are aligned with the read data sequences, the read data sequences may be preprocessed first, for example, a de-duplication may be made on the read data sequences that have been resent due to network/system abnormalities. When the page screenshots are aligned with the read data sequences, if one page screenshot fails to match a read data sequence, the missing read data sequence may be complemented according to the time of the page screenshot.

As shown in FIG. 3, the process of determining the prefetch data may specifically include steps below.

At step S301, an attention score between each page screenshot and each of the multiple read data sequences is determined based on the page screenshots and corresponding read data sequences that are aligned with each other.

In this embodiment, since each page screenshot is aligned with a read data sequence, in order to accurately reflect an impact of the display page redirection on the read data, the attention score between each page screenshot and each of the multiple read data sequences may be determined, that is, the attention score between each page screenshot and each read data sequence may be determined. The attention score is used for representing a degree of correlation between the current display page watched by the user and the data read before and after the current display page. In this way, based on viewing behaviors and data reading behaviors with a chronological order, the degree of correlation between the display page watched by the user and the read data can be better expressed, that is, the impact of the display page watched by the user on the user's data reading can be obtained.

In an optional embodiment, the attention score between each page screenshot and each of the multiple read data sequences may be determined through a BERT (Bidirectional Encoder Representations from Transformer) model.

At step S302, the prefetch data to be read by the target application next time is determined based on the attention score.

In this embodiment, since the attention scores are used for representing the degree of correlation between the current display page watched by the user and the data read before and after the current display page, a probability transfer matrix of the display page and a probability transfer matrix of the read data sequence may be constructed based on multiple attention scores for each page screenshot (each read data sequence corresponds to one attention score), so that the prefetch data to be read by the user next time can be determined based on the probability transfer matrixes.

The probability transfer matrixes are used to reflect a probability distribution of a dynamic process in which the read data behavior is transferred from one state to another, that is, to learn a law of the user's read data behavior. This law is represented as a probability transfer matrix through which the prefetch data to be read next time can be predicted.

A further explanation is given below. The multiple page screenshots record the viewing behavior of the user and contain rich information such as the correlation relationship among the scene area, the display page and the resource data distribution, and in the design of the target application, the scene area, the functional page and the distribution of the resource data of related components are basically in a one-to-one correspondence relationship. Therefore, after a current scene area of the user is determined through the page screenshot, it can be inferred which part of the resource data of the target application is being accessed. Then, combined with the user behavior data, a combined probability ranking of jumping from the current scene area (display page) to other related scene areas (other display pages) can be guessed, and then a probability ranking of the resource data to be accessed by the user next can be obtained. Based on the probability ranking, the prefetch data to be read by the user next time can be determined.

It should be noted that the process of determining the prefetch data shown in FIG. 3 indicates the essential connotation of determining the prefetch data based on the page screenshots and the read data sequences in this application, and all specific technical embodiments adopting this essential connotation are considered to fall within the protection scope of the application.

Based on the essential connotation of determining the prefetch data shown in FIG. 3, an optional technical implementation is proposed. In this implementation, a prediction model for determining the prefetch data may be constructed based on the idea of machine learning. The prediction model may be obtained by training a target neural network with corresponding training samples. In this way, the page screenshots and the read data sequences may be directly input into the prediction model to determine the prefetch data to be read next time.

The training samples used for training the prediction model may include multiple joint training samples. Each joint training sample includes multiple page screenshot samples and user behavior data samples. The actual read data sample is the data actually read by the target application. The actual read data sample is used as the true value in the training process. A loss function is constructed with the true value being served as a target of supervised learning, so that the loss value can be continuously reduced during the training process, and parameters of the target neural network can be continuously updated, thereby ensuring the target neural network continuously converge to obtain the prediction model.

When the prediction model is constructed by training the target neural network, a prediction model with stronger prediction performance can be trained through a large number of training samples, thereby improving the accuracy of the prediction model in determining the prefetch data.

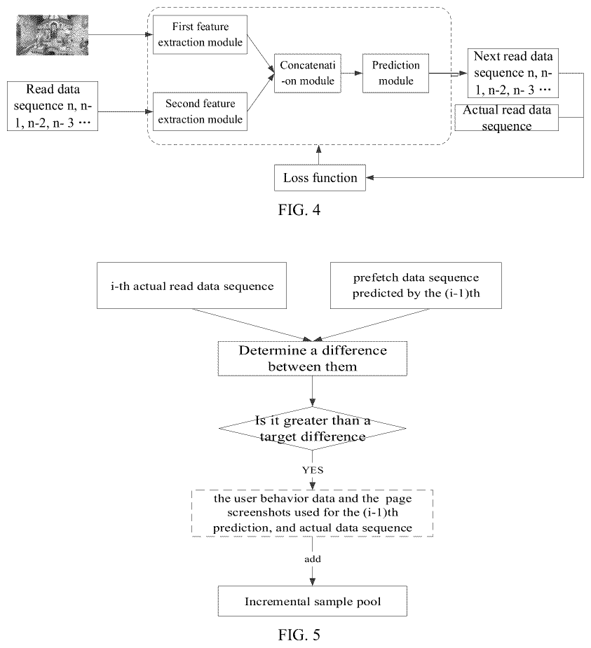

Reference is made to FIG. 4, which is a schematic diagram illustrating an overall flow of model training according to the present application. As shown in FIG. 4, the target neural network includes a first feature extraction module, a second feature extraction module, a concatenation module and a prediction module. In FIG. 4, the prediction module is illustrated by taking a Transformer model as an example. Referring to FIG. 4, the training process of the prediction model is described below.

First, the user behavior data samples include multiple read data sequence samples. Multiple page screenshot samples are input into the first feature extraction module to obtain first feature vectors corresponding to each of the page screenshot samples, and multiple read data sequence samples are input into the second feature extraction module to obtain second feature vectors corresponding to each of the read data sequence samples.

Then, combined vectors obtained by concatenating the first feature vectors and the second feature vectors are input into the prediction module to obtain the prefetch data sequence output by the prediction module. The concatenation module is configured to concatenate the first feature vectors and the second feature vectors.

Next, the parameters of the target neural network are updated multiple times based on the prefetch data sequences and the actual read data samples to obtain the prediction model.

In this embodiment, the first feature extraction module is configured to extract features from the page screenshot samples to form a feature map. The first feature extraction module may include multiple convolutional layers connected in sequence. Through the convolutional layers, features can be extracted from page screenshots at different scales to obtain a feature map, then the feature map is converted into feature vectors to obtain the first feature vectors.

The second feature extraction module may be configured to perform a vectorization processing on each of the read data sequence samples in a specified format to obtain the second feature vectors.

Next, the first feature vectors and corresponding second feature vectors are concatenated to obtain combined vectors. Then, multiple temporally continuous combined vectors are input into the prediction module, which may be a Transformer model. The multi-head Self-Attention mechanism is extensively used by the Transformer model. The algorithm adopted by the Transformer model is a temporal algorithm based on the attention mechanism. Thus, based on temporally continuous combined vectors, the degree of the correlation between the display pages of the target application and the read data may be learned through the prediction model.

After the prefetch data sequence output from the prediction module is obtained, a loss function may be constructed based on the prefetch data sequence and the actual read data sequence included in the actual reading data samples to obtain the loss value of the target neural network. Based on the loss value, the parameters of the target neural network are updated.

Thus, after multiple rounds of training, if the loss value is less than a target loss value and the LOSS curve conforms to an expected change, then the target neural network is converged, and the obtained prediction model may be deployed to online applications.

According to this implementation, since the prediction model is continuously trained with a large number of training samples, the prediction accuracy of the prediction model for prefetch data can be improved. After the prediction model is obtained through training, multiple page screenshots and read data sequences in the user behavior data may be input into the prediction model to obtain the prefetch data that to be read by the target application next time.

In specific implementation, the read data sequences and the page screenshots are aligned with each other based on the timestamps first. The multiple page screenshots and multiple read data sequences that are aligned are input into the first feature extraction module and the second feature extraction module, respectively, to output the first feature vectors and the second feature vectors. Then, multiple temporally continuous first feature vectors and second feature vectors are concatenated by the concatenation module to obtain multiple temporally continuous combined vectors. Finally, these combined vectors are input into the prediction model to obtain the prefetch data to be read by the target application next time.

Of course, when determining the prefetch data based on the prediction model, the prediction performance of the prediction model is related to the richness of the training samples. The richer the training samples, the better the generalization and robustness of the prediction model. Therefore, during the use of the target application, training samples are continuously collected to dynamically update the prediction model, thereby improving the prediction accuracy of the prediction model.

Accordingly, in an embodiment, a “self-driven” prediction model iteration mechanism may be constructed. Through this mechanism, the prediction model is caused to enter an automatic iteration cycle. As the users using the target application increase and more training samples are collected, the prediction ability of the prediction model will become more accurate, and only a little manual intervention is required to enable the prediction model to complete self-update iteration.

Reference is made to FIG. 5, which is a schematic flowchart of a self-iterative updating of the prediction model. Referring to FIG. 5, in the specific implementation, when an i-th data reading is executed by the target application, an actual read data sequence that is actually read through the i-th data reading and the prefetch data sequence corresponding to the i-th data reading can be obtained; and when the difference between the actual read data sequence for the i-th data reading and the prefetch data sequence output for the (i−1)-th data reading (the prefetch data sequence output for the (i-1)-th data reading is actually a data sequence predicted to be read through the i-th data reading) exceeds a target difference, the target user behavior data and the target page screenshots, based on which the prefetch data sequence for the (i−1)-th data reading is determined, are acquired; then the prediction model is updated based on the target user behavior data, the target page screenshots and the actual read data sequence. Here, “i” is an integer greater than or equal to 1.

In this embodiment, the i-th data reading may refer to any read request of the target application. That is, when the target application issues a read request and needs to read data each time, the actual data required to be read by the target application may be determined through the read request, and the actual data required to be read is the actual read data sequence, which may be specifically represented as an ID sequence as mentioned above. The identifier of the data to be read this time may be carried in the read request. Thus, by analyzing the read request, the actual read data sequence to be read through the i-th data reading may be acquired.

Since the prefetch data (that is, the prefetch data sequence) corresponding to each read request is predicted in advance before the read request, the difference between the actual read data sequence to be read through the i-th read request and the corresponding prefetch data sequence may be determined.

For example, when the target application issues a 5th read request, the actual read data sequence to be read by the read request is “01-02-03-06-08”, and before that, the prefetch data sequence to be read predicted through the 4th data request (compared with the actual read data sequence for the 5th read request) is “01-03-04-07-08”, then the difference between “01-02-03-06-08” and “01-03-04-07-08” can be determined.

The difference between the actual read data sequence to be read and the corresponding prefetch data sequence may include the inconsistency of the read data sequences and the inconsistency of the reading order of the read data sequences.

The difference between the actual read data sequence and the corresponding prefetch data sequence may be characterized by an error rate. Accordingly, the target difference may be represented by a target error rate. Specifically, it can be represented as a proportion of data that is inconsistent in the actual read data sequence and the prefetch data sequence. For example, three inconsistent data exists in “01-02-03-06-08” and “01-03-04-07-08”, the proportion is 60%, and the error rate is 60%.

When the difference is greater than the target difference, it indicates that the prediction accuracy of the i-th prefetching is not high. Then, the page screenshots and user behavior data used to predict the data to be read through the i-th reading may be re-input into the prediction model, and the prediction model is trained with the actual read data sequence actually read for the i-th reading as the true value to update the parameters of the prediction model, so that the prediction model can relearn the inaccurately predicted samples.

By adopting such implementation, when the prediction model is used online, the user behavior data and page screenshots obtained in real time online can be used to dynamically update the prediction model, so that the prediction model can continuously learn the behaviors of the current user group, thereby always ensuring the prediction accuracy of the prefetch data during the continuous use of the target application by the user group.

In an implementation manner, the target user behavior data and target page screenshots corresponding to the i-th reading may be taken as incremental samples and added to an incremental sample pool. Subsequently, the incremental samples newly added in the current period are periodically acquired from the incremental sample pool; and the prediction model is updated by using the incremental samples newly added in the current period as training samples and using the corresponding actual read data sequences as true values.

Based on the above description, when the prediction model is used online, it can be dynamically updated using the user behavior data and page screenshots obtained in real time online. In the specific implementation, the prediction model can be updated periodically. In this way, once it is determined that the difference between the prefetch data sequence and the corresponding actual read data sequence is greater than the target difference, the corresponding target user behavior data and target page screenshots are taken as incremental samples and added to the incremental sample pool.

An index table may be constructed for the incremental sample pool, and indexes of the incremental samples newly added in the current period may be recorded in the index table. In this way, when the prediction model needs to be updated, the incremental samples newly added in the current period may be determined based on the index table, and the prediction model is updated by using the incremental samples newly added in the current period as the training samples.

For example, the prediction model is updated once a week. In this case, when a new week comes (e.g., when every Sunday comes), the incremental samples newly added from Monday to the current time in the week may be retrieved and input into the prediction model, and the prediction model is continuously trained through the above training process to obtain an updated prediction model.

As another example, the prediction model is updated once a week. In this case, when a new week comes (e.g., when every Sunday comes), the incremental samples newly added from Monday to the current time in the week may be retrieved and incorporated into a full training sample set. The full training sample set is a set of all incremental samples from the current time to six months or a year ago, or it can be an existing basic training sample set combined with a set of incremental samples within a certain period. Then, the training samples in the full training sample set are input into the prediction model, and the prediction model is continuously trained through the above training process to obtain the updated prediction model. Compared with the previous training method, this training method can reduce the decay rate of the model in specific scenarios as much as possible, and improve the generalization ability.

In this way, the updated prediction model may be used to predict the prefetch data of the target application.

Of course, in some embodiments, the prediction model may also be evaluated. Specifically, the prediction model may be evaluated according to the evaluating process in the related art. For example, an evaluation data set is constructed and input into the prediction model for inference, and it is determined, based on the prediction result (prefetch data sequence) output by the prediction model, whether the prediction result meets target indicators. If it meets, the prediction model is confirmed to be ready for online operation.

Accordingly, each time the prediction model is updated by using the incremental samples, the updated prediction model is evaluated to determine whether the updated prediction model is better in the target indicators. If so, the updated prediction model is used as the latest version of the model for online operation. If not, the latest version of the prediction model is not released, and the prediction model before the updating continues to be used for online operation.

The target indicators may include an average accuracy rate of the prediction, a recall rate, a prediction range coverage, etc.

With reference to the hardware and software environment diagram shown in FIG. 1, when the prediction model is used to determine the prefetch data, the prediction model may be deployed on the second server or a terminal on which the target application runs. A mode of determining the prefetch data through the prediction model on the second server may be called a server mode, and a mode of determining the prefetch data through the prediction model on the terminal may be called a client mode.

It should be noted that in the client mode, the prefetch data is determined by the terminal itself, it is not necessary to send the page screenshots and user behavior data to the second server. Therefore, the occupation of network resources and the dependence on network bandwidth are avoided, thereby avoiding determining the prefetch data remotely and improving the efficiency of determining the prefetch data. In the server mode, the computing power of the server is greater than that of the terminal, the occupation of the computing resources on the terminal can be avoided, thereby reducing the performance consumption of the terminal and ensuring the endurance of the terminal.

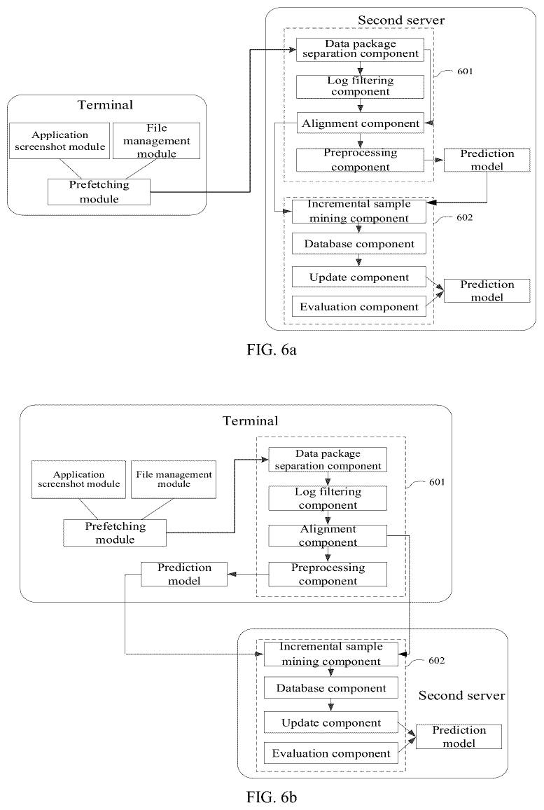

Referring to FIG. 6a and FIG. 6b, FIG. 6a shows the hardware and software environment diagram in the server mode, and FIG. 6b shows the hardware and software environment diagram in the client mode. As can be seen from FIG. 6a and FIG. 6b, in addition to the prediction model, a first component 601 related to determining the prefetch data and a second component 602 related to the iterative update of the prediction model are also included.

Referring to FIG. 6a and FIG. 6b, the first component 601 may include a data package separation component, a log filtering component, an alignment component and a preprocessing component. The second component 602 may include an incremental sample mining component, a database component, an update component and an evaluation component.

As shown in FIG. 6a, in the server mode, the first component 601, the second component 602 and the prediction model are all deployed in the second server. As shown in FIG. 6b, in the client mode, the first component 601 and the prediction model are deployed on the terminal, while the second component 602 is deployed on the second server.

The terminal selects to enter the server mode or the client mode according to its own performance configuration parameters. Of course, the terminal may also switch between the server mode and the client mode according to the performance configuration parameters during its own use process.

In specific implementation, the current performance configuration parameters of the terminal on which the target application runs may be acquired. When the current performance configuration parameters meet target conditions, the multiple page screenshots and the user behavior data are sent to the prediction model configured in the terminal to obtain the prefetch data to be read next time. When the current performance configuration parameters do not meet the target conditions, the multiple page screenshots and the user behavior data are sent to the second server to obtain the prefetch data to be read next time.

In the embodiment, the performance configuration parameters can reflect the hardware configuration, software configuration and operating system configuration of the terminal, and further reflect the overall performance of the terminal. Of course, the performance of the terminal will change dynamically with a continuous running of other applications and the increase of stored data. Therefore, the current performance configuration parameters may reflect a situation that the software and hardware carrying capacity of the terminal is consumed by the current applications and stored data.

The target conditions may be any one or a combination of multiple conditions such as the operating system being a target version of the operating system, the CPU occupancy rate of the terminal being lower than the target occupancy rate, and the remaining capacity of the memory of the terminal being not lower than the target capacity. The more content the target conditions contain, the higher requirements the performance configuration parameters of the terminal need to meet so as to use the prediction model configured on the terminal to predict the prefetch data.

In some embodiments, when the target application is installed, it can be determined whether to deploy the prediction model on the terminal according to the current performance configuration parameters of the terminal. For example, when the current performance configuration parameters meet the target conditions, the prediction model can be deployed on the terminal; otherwise, the prediction model is not deployed on the terminal.

Accordingly, during the use process of the target application, the client mode and the server mode can also be dynamically switched according to the current performance configuration parameters of the terminal, so that the prediction of the prefetch data is matched with the computing power of the terminal itself.

The first component and the second component shown in FIG. 6a and FIG. 6b are respectively introduced below.

In the first component, an output end of the data package separation component is connected to the log filtering component and the alignment component, the output end of the log filtering component is connected to an input end of the alignment component, the output end of the alignment component is connected to the input end of the preprocessing component, and the output end of the preprocessing component is used for inputting page screenshots and user behavior data that have been preprocessed to the prediction model.

The second component includes the incremental sample mining component, the database component, the update component and the evaluation component. The input end of the incremental sample mining component may be connected to the output end of the alignment component and the output end of the prediction model. The incremental sample mining component is configured to receive the read data sequences and page screenshots output by the alignment component, as well as the prefetch data determined by the prediction model (for example the prefetch data determined last time), so as to perform difference comparison with the read data sequence output by the alignment component this time.

The output end of the incremental sample mining component is connected to the database component. The incremental sample mining component is configured to store the read data sequence and page screenshots output by the alignment component as well as the prefetch data determined by the prediction model into a database. The update component is connected to the database, and is configured to, when there are newly added incremental samples in the database, read out the newly added incremental samples, and use the newly added incremental samples to update the prediction model. The evaluation component is configured to evaluate the prediction model.

The second component 602 is deployed in the second server. The prediction model in the second server is updated through the second component 602. When it is determined through evaluation that the target indicators are improved, the prediction model is sent to the terminal so that the terminal can deploy the latest version of the prediction model.

It should be noted that in the server mode, the page screenshots are sent in the form of short videos on a path from the target application to the preprocessing component, that is, multiple page screenshots are encoded into a video and then sent to the preprocessing component on the path, and then the multiple page screenshots are obtained by decoding through the preprocessing component.

An overall process of the data reading method according to the application is described below with reference to FIG. 6a by taking using a game APP in a mobile terminal as an example.

At S1, during the running of the game, the display page of the current scene is sampled at a preset frequency, the Nvidia Game Stream interface is called to obtain image frames currently cached in the display buffer of the graphic memory of the GPU, a simple adjustment of the direction and size is performed on each extracted image frame and each extracted image frame is marked with a timestamp, the processed image frames are encoded into a video, and then the video is truncated into a short video A of 10-30 s and sent to the prefetching module. Thus, the image frames in the short video A are the page screenshots required for prefetching.

At S2, the data reading log of the target application is obtained by the file management module, and sent to the prefetching module, where the data reading log includes multiple read data sequences, and each read data sequence has a corresponding timestamp.

At S3, read data sequences that match a time range (from the starting timestamp to the ending timestamp) of the short video A are searched from the data reading log by the prefetching module, and then packeted into a log package A and sent to the data package separation component in the second server.

At S4, the log package A is separated into the short video A and several read data sequences by the data package separation component; and the short video A is sent to the alignment component and the several read data sequences are sent to the log filtering component.

At S5, the log filtering component checks duplicate read data sequences among the received several read data sequences and removes the duplicate read data sequences; after the missing read data sequences in a certain period are complemented, the processed read data sequences are sent to the alignment component.

At S6, the alignment component again aligns the time of each image frame in the short video A with the time of the read data sequences, packets the aligned short video A and the read data sequences into a data group B, and sends a copy of the data group B to the incremental sample mining component and sends the data group B to the preprocessing component.

At S7, the received data group B is separated into a short video A and read data sequences by the preprocessing component, the short video A is decoded to obtain several page screenshots; and the matching page screenshots are searched based on the timestamp of the read data sequences to achieve the re-alignment of the read data sequences and the page screenshots.

Then, the multiple page screenshots and their corresponding read data sequences are sent to the prediction model for inference, so as to obtain the identifier, output by the prediction model, of the prefetch data to be read by the target application next time.

At S8, the second server feeds back the identifier of the prefetch data to be read next time to the prefetching module.

At S9, the prefetching module encapsulates a data download request based on the identifier of the prefetch data to be read next time, and sends the data download request to the first server.

At S10, the prefetching module receives the prefetch data returned by the first server, and stores the prefetch data in the external storage device of the terminal.

At S11, in response to the next read request for the target application, the data required by the read request is determined. If the data required by the read request has been stored in the external storage device, it is read from the external storage device; if only part of the data required by the read request are stored in the external storage device, a new data download request is constructed for the remaining data that are not stored in the external storage device to obtain the remaining data from the first server.

For the update of the prediction model, reference may be made to the description in the above embodiments in detail, and will not be described exemplarily here.

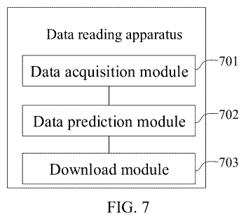

Based on the same creative concept, this application further provides a data reading apparatus. FIG. 7 is a schematic framework diagram of the data reading apparatus. As shown in FIG. 7, the data reading apparatus includes a data acquisition module 701, a data prediction module 702 and a download module 703.

The data acquisition module 701 is configured to acquire user behavior data and multiple page screenshots of a target application prior to a current moment. The page screenshots are obtained by capturing the display page of the target application.

The data prediction module 702 is configured to determine prefetch data to be read by the target application next time based on the multiple page screenshots and the user behavior data.

The download module 703 is configured to download the prefetch data from a first server and store the prefetch data into a local storage device, so that when a next read request for the target application hits the prefetch data, the prefetch data is read from the local storage device.

In some embodiments, the user behavior data includes multiple read data sequences, and the data reading apparatus further includes:
an alignment module, configured to align the multiple page screenshots and the multiple read data sequences based on the respective timestamps of the multiple page screenshots and the respective timestamps of the multiple read data sequences;
when the user behavior data includes multiple read data sequences, the data prediction module 702 includes:
an attention score determination unit, configured to determine an attention score between each page screenshot and each of the multiple read data sequences based on the page screenshots and the corresponding read data sequences that are aligned with each other; and
a prediction unit, configured to determine the prefetch data to be read by the target application next time based on the attention score.

In some embodiments, the data prediction module 702 includes:
an input unit, configured to input the multiple page screenshots and the user behavior data into a prediction model to obtain the prefetch data to be read by the target application next time.

The prediction model is obtained by training a target neural network with multiple joint training samples as inputs and an actual read data sample corresponding to each joint training sample as a true value.

Each joint training sample includes multiple page screenshot samples and user behavior data samples, and the actual read data sample is the data actually read by the target application.

In some embodiments, the data reading apparatus further includes:
a first data sequence acquisition module, configured to, when the i-th data reading is executed by the target application, acquire the actual read data sequence actually read through the i-th data reading and the prefetch data sequence corresponding to the i-th data reading; where i is an integer greater than or equal to 1;
a second data sequence acquisition module, configured to, when the difference between the actual read data sequence and the prefetch data sequence exceeds a target difference, acquire the target user behavior data and the target page screenshots used when determining the prefetch data sequence corresponding to the i-th data reading; and
a model update module, configured to update the prediction model based on the target user behavior data, the target page screenshots and the actual read data sequences.

In some embodiments, the data reading apparatus further includes:
a sample addition module, configured to take the target user behavior data and the target page screenshots corresponding to the i-th data reading as incremental samples, and add the incremental samples to an incremental sample pool.

The model update module includes:
a sample update unit, configured to periodically acquire the incremental samples newly added in the current period from the incremental sample pool;
a model update unit, configured to update the prediction model with the incremental samples newly added in the current period as inputs and the corresponding actual read data sequences as the true value.

In some embodiments, the user behavior data sample includes multiple read data sequence samples, and the prediction model is trained as follows:
acquiring a first feature vector corresponding to each of the multiple page screenshot samples and a second feature vector corresponding to each of the multiple read data sequence samples;
obtaining a combined vector by concating the first feature vector and the second feature vector;
obtaining the prefetch data sequence output by the target neural network based on the combined vector;
updating the parameters of the target neural network multiple times based on the prefetch data sequence and the actual read data sample to obtain the prediction model.

In some embodiments, the data reading apparatus further includes:
a configuration parameter acquisition module, configured to acquire current performance configuration parameters of a terminal running the target application.

The data prediction module 702 includes:
a first prediction mode unit, configured to when the current performance configuration parameters meet a target condition, send the multiple page screenshots and the user behavior data to the prediction model provided in the terminal to obtain the prefetch data to be read next time; and
a second prediction mode unit, configured to when the current performance configuration parameters do not meet the target condition, send the multiple page screenshots and the user behavior data to the second server to obtain the prefetch data to be read next time.

In some embodiments, the data reading apparatus further includes:
a data package acquisition module, configured to acquire a launching operation package and a launching image package of the target application in advance before the target application is installed; where the launching image package includes startup data of the target application; and
an application launching module, configured to after launching the target application through the launching operation package, in response to a read request for the target application, read data corresponding to the read request from the launching image package and/or the first server; where the first server includes all the original data of the target application.

It should be noted that the apparatus embodiment is similar to the method embodiment, so the description thereof is relatively simple, and the relevant parts can refer to the method embodiment.

An embodiment of this application further discloses an electronic device, including a memory, a processor and a computer program stored on the memory and executable on the processor. When the processor executes the computer program, the data reading method as described is implemented.

An embodiment of this application further discloses a computer readable storage medium, and the computer program stored thereon causes the processor to execute the data reading method of this application.

An embodiment of this application further discloses a computer program product, including computer programs/instructions. When the computer programs/instructions are executed by the processor, the data reading method as described is implemented.

For the apparatus embodiment, since it is basically similar to the method embodiment, the description is relatively simple, and the relevant parts can refer to the partial description of the method embodiment.

Various embodiments in this specification are described in a progressive manner, and each embodiment focuses on the differences from other embodiments. The same or similar parts among the embodiments can be referred to each other.

Those skilled in the art should understand that the embodiments of this application may be provided as a method, an apparatus, or a computer program product. Therefore, the embodiments of this application may take the form of a completely hardware embodiment, a completely software embodiment, or an embodiment combined with software and hardware. Moreover, the embodiments of this application may take the form of a computer program product implemented on one or more computer-executable storage media (including but not limited to disk storage, CD-ROM, optical storage, etc.) containing computer-executable program code.

The embodiments of this application are described with reference to the flowcharts and/or block diagrams of the method, terminal device (system), and computer program product according to the embodiments of this application. It should be understood that each process and/or block in the flowcharts and/or block diagrams, and the combination of the processes and/or blocks in the flowcharts and/or block diagrams may be implemented by computer program instructions. These computer program instructions may be provided to the processor of a general-purpose computer, a special-purpose computer, an embedded processor or other programmable data processing terminal devices to generate a machine, so that the instructions executed by the processor of the computer or other programmable data processing terminal devices generate a device for implementing the functions specified in one process or multiple processes and/or one block or multiple blocks in the flowcharts and/or block diagrams.

These computer program instructions may also be stored in a computer-readable memory that can guide the computer or other programmable data processing terminal devices to work in a specific manner, so that the instructions stored in the computer-readable memory generate a manufactured article including an instruction device, and the instruction device implements the functions specified in one process or multiple processes and/or one block or multiple blocks in the flowcharts and/or block diagrams.

These computer program instructions may also be loaded onto a computer or other programmable data processing terminal devices, so that a series of operation steps are executed on the computer or other programmable terminal devices to generate computer-implemented processing. Thus, the instructions executed on the computer or other programmable terminal devices provide steps for implementing the functions specified in one process or multiple processes and/or one block or multiple blocks in the flowcharts and/or block diagrams.

Although the preferred embodiments of the embodiments of this application have been described, those skilled in the art can make other changes and modifications to these embodiments once they know the basic creative concept. Therefore, the appended claims are intended to be construed to include the preferred embodiments and all changes and modifications falling within the scope of the embodiments of this application.

Finally, it should be noted that, relational terms such as “first” and “second” are only used to distinguish one entity or operation from another entity or operation, and do not necessarily require or imply any actual relationship or order between these entities or operations. Moreover, the term “comprise”, “include” or any other variation thereof is intended to cover a non-exclusive inclusion, such that a process, method, article or terminal device including a series of elements not only includes those elements, but also includes other elements not explicitly listed, or also includes elements inherent to such a process, method, article or terminal device. Without more limitations, an element defined by the phrase “comprising a . . . ” does not exclude the presence of other identical elements in the process, method, article or terminal device that includes the element.

The above has provided a detailed introduction to a data reading method, a data reading apparatus and a device provided by this application. Specific examples are used in this document to illustrate the principle and embodiment of this application. The description of the above embodiments is only used to help understand the method and its core idea of this application. At the same time, for those of ordinary skill in the art, based on the idea of this application, there will be changes in the specific embodiment and application scope. In summary, the content of this specification should not be construed as a limitation on this application.

Those skilled in the art will easily conceive of other embodiments of the present disclosure after considering the specification and practicing the disclosure disclosed herein. The present disclosure is intended to cover any variations, uses or adaptive changes of the present disclosure. These variations, uses or adaptive changes follow the general principles of the present disclosure and include the common knowledge or conventional technical means in the technical field not disclosed by the present disclosure. The specification and embodiments are only regarded as exemplary, and the true scope and spirit of the present disclosure are pointed out by the following claims. It should be understood that the present disclosure is not limited to the precise structure described above and shown in the drawings, and various modifications and changes can be made without departing from its scope. The scope of the present disclosure is limited only by the appended claims.

The terms “an embodiment”, “embodiment” or “one or more embodiments” as used herein mean that a particular feature, structure or characteristic described in combination with the embodiment is included in at least one embodiment of the present disclosure. In addition, please note that the examples of “in one embodiment” herein do not necessarily all refer to the same embodiment.

In the specification provided herein, a large number of specific details are described. However, it can be understood that the embodiments of the present disclosure can be practiced without these specific details. In some instances, well-known methods, structures and techniques are not shown in detail so as not to obscure the understanding of the specification.

In the claims, any reference symbols between parentheses should not be construed as a limitation on the claims. The word “comprise” does not exclude the existence of elements or steps not listed in the claims. The word “a” or “an” before an element does not exclude the existence of a plurality of such elements. The present disclosure can be implemented by means of hardware including several different elements and by means of a suitably programmed computer. In the unit claims listing several devices, several of these devices may be embodied by the same hardware item. The use of the words first, second, and third, etc. does not indicate any order. These words can be interpreted as names.

Finally, it should be noted that the above embodiments are only used to illustrate the technical solution of the disclosure, rather than limiting it. Although the disclosure has been described in detail with reference to the foregoing embodiments, those skilled in the art should understand that modifications can be made to the technical solutions described in the foregoing embodiments, or equivalent substitutions can be made to some of the technical features. However, these modifications or substitutions do not cause the essence of the corresponding technical solutions to deviate from the spirit and scope of the technical solutions of the embodiments of the present disclosure.

1. A data reading method, comprising:
acquiring user behavior data and multiple page screenshots of a target application prior to a current moment, wherein the page screenshots are obtained by capturing a display page of the target application;
determining, based on the multiple page screenshots and the user behavior data, prefetch data to be read by the target application next time; and
downloading the prefetch data from a first server and storing the prefetch data in a local storage device, so that when a next read request for the target application hits the prefetch data, the prefetch data is read from the local storage device.

2. The method according to claim 1, wherein the user behavior data comprises multiple read data sequences, and the method further comprises:
aligning, based on respective timestamps of the multiple page screenshots and respective timestamps of the multiple read data sequences, the multiple page screenshots with the multiple read data sequences;
the determining, based on the multiple page screenshots and the user behavior data, prefetch data to be read by the target application next time comprises:
determining, based on the page screenshots and corresponding read data sequences that are aligned with each other, an attention score between each of the page screenshots and the multiple read data sequences; and
determining, based on the attention score, the prefetch data to be read by the target application next time.

3. The method according to claim 1, wherein the determining, based on the multiple page screenshots and the user behavior data, prefetch data to be read by the target application next time comprises:
inputting the multiple page screenshots and the user behavior data into a prediction model to obtain the prefetch data to be read by the target application next time;
wherein the prediction model is obtained by training a target neural network with multiple joint training samples as inputs and with actual read data samples corresponding to the joint training samples as true values;
wherein each of the joint training samples comprises multiple page screenshot samples and user behavior data samples, and the actual read data samples are data actually read by the target application.

4. The method according to claim 3, further comprising:
when an i-th data reading is executed by the target application, acquiring the actual read data sequence actually read through the i-th data reading and a corresponding prefetch data sequence for the i-th data reading, wherein i is an integer greater than or equal to 1;
in response to a difference between the actual read data sequence and the prefetch data sequence exceeding a target difference, acquiring a target user behavior data and a target page screenshot based on which the prefetch data sequence for the i-th data reading is determined; and
updating the prediction model based on the target user behavior data, the target page screenshot and the actual read data sequence.

5. The method according to claim 4, further comprising:
taking the target user behavior data and the target page screenshot corresponding to the i-th data reading as an incremental sample, and adding the incremental sample to an incremental sample pool;
the updating the prediction model based on the target user behavior data, the target page screenshot and the actual read data sequence comprises:
acquiring incremental samples newly added in a current period from the incremental sample pool periodically; and
updating the prediction model with the incremental samples newly added in the current period as inputs and the corresponding actual read data sequence as the true value.

6. The method according to claim 3, wherein the user behavior data sample comprises multiple read data sequence samples, and the prediction model is trained by:
acquiring first feature vectors corresponding to each of the multiple page screenshot samples and second feature vectors corresponding to each of the multiple read data sequence samples;
obtaining combined vectors by concating the first feature vectors with the second feature vectors;
obtaining the prefetch data sequence output by the target neural network based on the combined vectors; and
updating, based on the prefetch data sequence and the actual read data sample, parameters of the target neural network multiple times to obtain the prediction model.

7. The method according to claim 3, further comprising:
acquiring current performance configuration parameters of a terminal running the target application;
the determining, based on the multiple page screenshots and the user behavior data, prefetch data to be read by the target application next time comprises:
in response to the current performance configuration parameters meeting target conditions, sending the multiple page screenshots and the user behavior data to the prediction model provided in the terminal to obtain the prefetch data to be read next time;
in response to the current performance configuration parameters not meeting the target conditions, sending the multiple page screenshots and the user behavior data to a second server to obtain the prefetch data to be read next time.

8. The method according to claim 1, comprising:
acquiring a launching operation package and a launching image package of the target application in advance before the target application is installed; wherein the launching image package comprises startup data of the target application;
after the target application is launched through the launching operation package, in response to a read request of the target application, reading data corresponding to the read request from the launching image package and/or the first server, wherein the first server comprises all original data of the target application.

9. (canceled)

10. An electronic device, comprising a memory, a processor, and a computer program that is stored on the memory and executable on the processor, wherein the computer program, when executed by the processor, causes the processor to execute operations of:
acquiring user behavior data and multiple page screenshots of a target application prior to a current moment, wherein the page screenshots are obtained by capturing a display page of the target application;
determining, based on the multiple page screenshots and the user behavior data, prefetch data to be read by the target application next time; and
downloading the prefetch data from a first server and storing the prefetch data in a local storage device, so that when a next read request for the target application hits the prefetch data, the prefetch data is read from the local storage device.

11. The electronic device according to claim 10, wherein the user behavior data comprises multiple read data sequences, and the processor is further configured to execute operations of:
aligning, based on respective timestamps of the multiple page screenshots and respective timestamps of the multiple read data sequences, the multiple page screenshots with the multiple read data sequences;
the determining, based on the multiple page screenshots and the user behavior data, prefetch data to be read by the target application next time comprises:
determining, based on the page screenshots and corresponding read data sequences that are aligned with each other, an attention score between each of the page screenshots and the multiple read data sequences; and
determining, based on the attention score, the prefetch data to be read by the target application next time.

12. The electronic device according to claim 10, wherein the determining, based on the multiple page screenshots and the user behavior data, prefetch data to be read by the target application next time comprises:
inputting the multiple page screenshots and the user behavior data into a prediction model to obtain the prefetch data to be read by the target application next time;
wherein the prediction model is obtained by training a target neural network with multiple joint training samples as inputs and with actual read data samples corresponding to the joint training samples as true values;
wherein each of the joint training samples comprises multiple page screenshot samples and user behavior data samples, and the actual read data samples are data actually read by the target application.

13. The electronic device according to claim 12, the processor is further configured to execute operations of:
when an i-th data reading is executed by the target application, acquiring the actual read data sequence actually read through the i-th data reading and a corresponding prefetch data sequence for the i-th data reading, wherein i is an integer greater than or equal to 1;
in response to a difference between the actual read data sequence and the prefetch data sequence exceeding a target difference, acquiring a target user behavior data and a target page screenshot based on which the prefetch data sequence for the i-th data reading is determined; and
updating the prediction model based on the target user behavior data, the target page screenshot and the actual read data sequence.

14. The electronic device according to claim 13, wherein the processor is further configured to execute operations of:
taking the target user behavior data and the target page screenshot corresponding to the i-th data reading as an incremental sample, and adding the incremental sample to an incremental sample pool;
the updating the prediction model based on the target user behavior data, the target page screenshot and the actual read data sequence comprises:
acquiring incremental samples newly added in a current period from the incremental sample pool periodically; and
updating the prediction model with the incremental samples newly added in the current period as inputs and the corresponding actual read data sequence as the true value.

15. The electronic device according to claim 12, wherein the user behavior data sample comprises multiple read data sequence samples, and the prediction model is trained by:
acquiring first feature vectors corresponding to each of the multiple page screenshot samples and second feature vectors corresponding to each of the multiple read data sequence samples;
obtaining combined vectors by concating the first feature vectors with the second feature vectors;
obtaining the prefetch data sequence output by the target neural network based on the combined vectors; and
updating, based on the prefetch data sequence and the actual read data sample, parameters of the target neural network multiple times to obtain the prediction model.

16. The electronic device according to claim 12, wherein the processor is further configured to execute operations of:
acquiring current performance configuration parameters of a terminal running the target application;
the determining, based on the multiple page screenshots and the user behavior data, prefetch data to be read by the target application next time comprises:
in response to the current performance configuration parameters meeting target conditions, sending the multiple page screenshots and the user behavior data to the prediction model provided in the terminal to obtain the prefetch data to be read next time;
in response to the current performance configuration parameters not meeting the target conditions, sending the multiple page screenshots and the user behavior data to a second server to obtain the prefetch data to be read next time.

17. The electronic device according to claim 10, wherein the processor is further configured to execute operations of:
acquiring a launching operation package and a launching image package of the target application in advance before the target application is installed; wherein the launching image package comprises startup data of the target application;
after the target application is launched through the launching operation package, in response to a read request of the target application, reading data corresponding to the read request from the launching image package and/or the first server, wherein the first server comprises all original data of the target application.

18. A non-transient computer readable storage medium storing computer readable instructions, wherein the computer readable instructions, when executed by one or more processors, cause the one or more processors to perform the method according to claim 1.
